(19) United States
(12) Patent Application Publication
(10) Pub. No.: US 2007/0223228 A1
(43) Pub. Date: Sep. 27, 2007

(54) Multipurpose decorative ground lighting system

(76) Inventor: Hon Kwok Cheng, Hong Kong (HK)

Correspondence Address: RABIN & Berdo, PC, 1101 14TH STREET, NW, SUITE 500, WASHINGTON, DC, 20005, US

(21) Appl. No.: 11/471,569

(22) Filed: Jun. 21, 2006

(30) Foreign Application Priority Data
Mar. 27, 2006 (CN) 200620018532.9

(51) Int. Cl. F21V 23/04

(52) U.S. Cl. 362/276

(57) ABSTRACT

The present invention provides a multipurpose decorative ground lighting system comprising a plurality of ground stakes; a plurality of soft plastic bodies configured as a figure of animal or human being and connected together through conducting wires, each of said soft plastic bodies being supported by the ground stake; a printed circuit board and a jiggling motor that are mutually coupled and arranged within each of the soft plastic bodies; and wherein a self-contained movement sensor and a self-contained light source sensor are connected to one of the printed circuit boards The lighting system may be activated by the self-contained movement sensor when the movement occurs in the vicinity of the lighting system to start moving and singing, thus greatly heightening the joyous and festive atmosphere during festival seasons and bringing people with warmth, peace, joy and happiness.

### FIELD OF THE INVENTION

The present invention relates to a ground lighting system, and particularly to a novel multipurpose decorative ground lighting system substantially made of soft plastic materials.

### BACKGROUND OF THE INVENTION

Water pipe lamps and light strings account for most of currently available ground-mounted lamp fixtures, some of which may form a chasing of light, but such a chasing overall gives out less motion feeling and a dull decorative effect. Designers must put more efforts into artificial modelings and colors in order to display various and wonderful styles.

The present invention is to provide a decorative ground lighting system that has a totally new concept and design, essentially characterized in that it generates a fantastic animated effect, thus making the light become flashing colorful light and heightening the joyous and festive atmosphere.

### SUMMARY OF THE INVENTION

An object of the present invention is to provide a multipurpose decorative ground lighting system that may jiggle and sing when people move in the vicinity of the lighting system, thus generating an animated effect to fill people with joy and happiness.

To attain this, the multipurpose decorative ground lighting system according to the invention comprises:
plurality of ground stakes;
a plurality of soft plastic bodies configured as a figure of animal or human being and connected together through conducting wires, each of said soft plastic bodies being supported by the ground stake;
a printed circuit board and a jiggling motor that are mutually coupled and arranged within each of the soft plastic bodies; and

wherein a self-contained movement sensor and a self-contained light source sensor are connected to one of the printed circuit boards.

The printed circuit boards within the soft plastic bodies are respectively connected to self-contained lights such as micro-bulbs, so that the lovely enameled figures of animals or human beings can be seen at night.

In one preferred embodiment of the invention, the printed circuit boards within the soft plastic bodies are respectively connected to self-contained speakers.

The soft plastic bodies are respectively provided at their bottoms with a power switch connected to the printed circuit board.

According to the invention, the lighting system may be activated by the self-contained movement sensor when the movement occurs in the vicinity of the lighting system, for example within the region of one meter. The light emitted by the light sources arranged within the soft plastic bodies makes the bodies visible at night. The animal or human being shaped soft plastic bodies may be driven by the motors to jiggle and play music through the speakers. With the jiggling and the music, the lighting system of the invention can greatly heighten the joyous and festive atmosphere and bring people with warmth, peace, joy and happiness during festival seasons.

The invention will now be described in more detail with reference to the accompanying figure drawings.

### BRIEF DESCRIPTION OF THE DRAWINGS

FIG. 1 is a pictorial view of the construction of the multipurpose decorative ground lighting system according to one embodiment of the invention.

FIG. 2 is a schematic diagram of an example circuit used in the lighting system of FIG. 1.

### DETAILED DESCRIPTION OF THE INVENTION

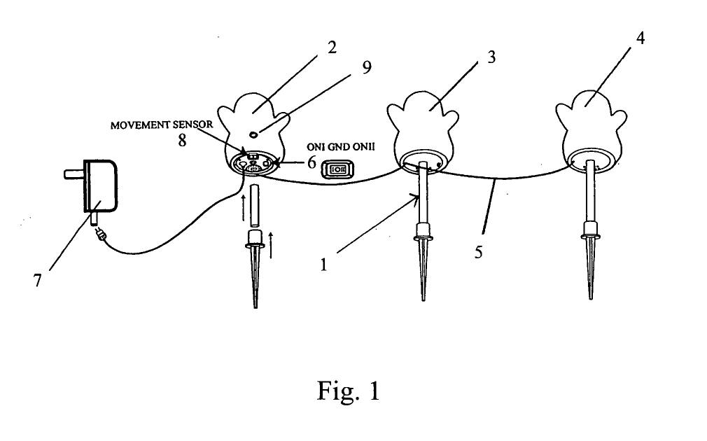

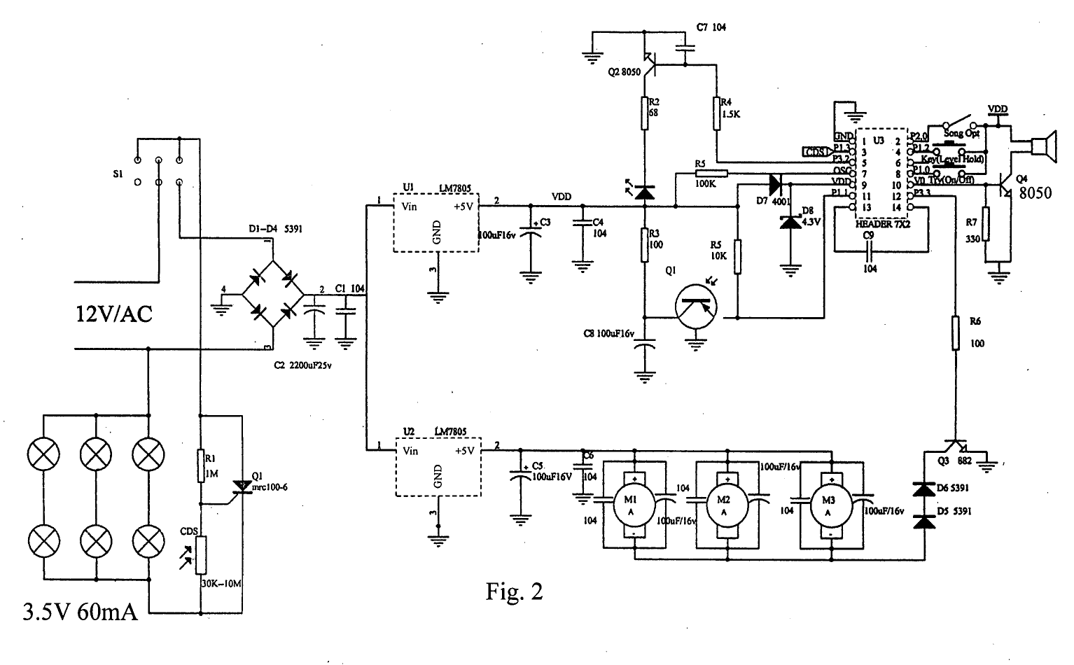

Referring to FIG. 1, there is illustrated a multipurpose decorative ground lighting system. FIG. 2 illustrates a schematic diagram of an example circuit used in the lighting system of FIG. 1. The lighting system shown in FIG. 1 comprises three soft plastic bodies 2, 3, 4 which are configured as a figure of animal or human being and connected together through conducting wires 5. The soft plastic bodies 2, 3, 4 are respectively supported by ground stakes 1. A printed circuit board and a jiggling motor that are mutually coupled are arranged within each of the soft plastic bodies 2, 3, 4. The soft plastic bodies may be driven to jiggle by the motors. The printed circuit board within the first soft plastic body 2 is connected to a movement sensor 8 and a light source sensor (CDS). The movement sensor 8 can cause activation of the printed circuit boards when detecting the nearby movement, without being substantially affected by surrounding light and noises. In this embodiment, the printed circuit boards are respectively connected to self-contained light sources, for example micro-bulbs, so that the lovely enameled figures of animals or human beings can be seen at night. Also, the printed circuit boards are respectively connected to self-contained speakers, through which music may be played after the movement sensor 8 is activated. A power switch 6, which is connected to the printed circuit board, is positioned at the bottom of the soft plastic body for controlling turning-on and turning-off of the power supply.

The micro-bulbs can turn off at day and turn on at night automatically under control of the light source sensor, thus attaining low power consumption.

The soft plastic bodies may be configured as a figure of human being or animal, such as Santa Claus, snowman, deer and the like, or combination thereof. The bodies may be enameled for generating colorful effect.

The lighting system of the invention is suitable for outdoor and indoor applications, in conjunction with an AC adaptor 7.

Having sufficiently described the nature of the present invention, it is stated that insofar as its basic principle is not altered, changed or modified it may be subjected to variations of detail. In this regard, we would highlight that the size and shape of the soft plastic bodies are independent of scope of the invention. The use of movement sensor 8 within the soft plastic body, the connection of the printed circuit board and the motor serving for driving the soft plastic bodies to jiggle and play music when people move in the vicinity of the lighting system should fall into the scope of this invention.

What is claimed is:

1. A multipurpose decorative ground lighting system, comprising
a plurality of ground stakes;
a plurality of soft plastic bodies configured as a figure of animal or human being and connected together through conducting wires, each of said soft plastic bodies being supported by the ground stake;
a printed circuit board and a jiggling motor that are mutually coupled and arranged within each of the soft plastic bodies; and
wherein a self-contained movement sensor and a self-contained light source sensor are connected to one of the printed circuit boards.

2. The lighting system as claimed in claim 1, characterized in that the printed circuit boards within the soft plastic bodies are respectively connected to self-contained lights under control of the light source sensor.

3. The lighting system as claimed in claim 1, characterized in that the printed circuit boards within the soft plastic bodies are respectively connected to self-contained speakers.

4. The lighting system as claimed in claim 2, characterized in that the printed circuit boards within the soft plastic bodies are respectively connected to self-contained speakers.

5. The lighting system as claimed in claim 3, characterized in that the soft plastic bodies are respectively provided at their bottoms with a power switch connected to the printed circuit board.

6. The lighting system as claimed in claim 4, characterized in that the soft plastic bodies are respectively provided at their bottoms with a power switch connected to the printed circuit board.
